(19) United States
(12) Patent Application Publication
(10) Pub. No.: US 2023/0297539 A1
(43) Pub. Date: Sep. 21, 2023

(54) PORTABLE CLOUD SERVICES FOR MEDIA AND DATA DISTRIBUTION

(71) Applicant: Streaming Global, Inc., Alpharetta, GA (US)

(72) Inventors: William M. Ortega, III, Lawrenceville, GA (US); Richard Oesterreicher, Alpharetta, GA (US); Craig Murphy, Suwanee, GA (US)

(21) Appl. No.: 18/171,581

(22) Filed: Feb. 20, 2023

Related U.S. Application Data
(60) Provisional application No. 63/321,192, filed on Mar. 18, 2022.

(51) Int. Cl. G06F 16/11; G06F 16/182

(52) U.S. Cl. CPC G06F 16/116; G06F 16/182

(57) ABSTRACT

The present platform includes a portable computing device comprising at least one hardware processor. The platform is configured to perform operations including receiving content data at a portable computing device, and processing the content data using the portable computing device, such that the processed data is stored as one or more processed content files in a streaming file format that can be distributed to and consumed by end users at one or more downstream devices. The platform is further configured to receive, at the portable computing device, a request for at least one file, of the processed content files, and distribute the requested at least one file to one or more downstream devices.

### RELATED APPLICATION

Under provisions of 35 U.S.C. § 119(e), the Applicant claims benefit of U.S. Provisional Application No. 63/321,192 filed on Mar. 18, 2022, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to use of portable devices for providing cloud services.

### BACKGROUND

Cloud computing generally refers to the on-demand availability of computer system resources, especially data storage and computing power, without direct active management by a user. A cloud often has functions distributed over multiple locations, each location being a datacenter. Cloud software media applications are currently deployed in such datacenters on powerful, expensive servers. Access to the servers generally uses a REpresentational State Transfer (REST) Application Programming Interface (API).

That is, cloud services typically rely on datacenters including a relatively large number of relatively powerful server computers to provide access to a service using one or more REST APIs. In a RESTful service, requests made to a resource elicit a response with a payload. For example, the response can confirm that the resource state has been changed. The response can also include hypertext links to related resources. By using a stateless protocol and standard operations, RESTful systems aim for fast performance, reliability, and the ability to grow by reusing components that can be managed and updated without affecting the system as a whole.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A REST API may be abstracted from the actual internal implementation. Using a layered approach, the top layer implements the API calling sequence. The next layer adjusts the incoming parameters for the underlying platform, and the final layer implements the actual API operations. The present platform includes a subset of standard REST APIs, the use of which can significantly reduce complexity of software components required to deploy applications and/or services. Reducing the software complexity allows the software to be deployed on hardware other than the high-powered servers of a datacenter. For example, cloud software can be deployed on significantly smaller and less complex devices, including mobile devices and tablets, taking advantage of advances in computing power and energy efficiency in the mobile device and tablet computing space. In this way the same API can be implemented on many different hardware/software platforms depending on the capabilities of each respective platform. Being able to provide cloud software using mobile hardware enables applications to operate even when not connected to the internet as long as a local network connection to the mobile device is available.

In one aspect, the present invention includes a system having a portable computing device comprising at least one hardware processor. The platform is configured to perform operations including receiving content data at a portable computing device, and processing the content data using the portable computing device, such that the processed data is stored as one or more processed content files in a streaming file format that can be distributed to and consumed by end users at one or more downstream devices. The platform is further configured to receive, at the portable computing device, a request for at least one file, of the processed content files, and distribute the requested at least one file to one or more downstream devices.

In another aspect, the present invention includes a method comprising receiving content data at a portable computing device, and processing the content data using the portable computing device, such that the processed data is stored as one or more processed content files in a streaming file format that can be distributed to and consumed by end users at one or more downstream devices. The method further includes receiving, at the portable computing device, a request for at least one file, of the processed content files, and distributing the at least one file, of the processed content files, to one or more downstream devices.

In yet another aspect, the present invention includes one or more non-transitory computer readable media comprising instructions which, when executed by one or more hardware processors, causes performance of operations including receiving content data at a portable computing device, and processing the content data using the portable computing device, such that the processed data is stored as one or more processed content files in a streaming file format that can be distributed to and consumed by end users at one or more downstream devices. The operations may further include receiving, at the portable computing device, a request for at least one file, of the processed content files, and distributing the at least one file, of the processed content files, to one or more downstream devices.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment for a platform for providing portable cloud services for media and data distribution consistent with the present disclosure;

FIG. 2 is a flowchart illustrating a method for using the platform for providing portable cloud services; and

FIG. 3 is a block diagram of a system including a computing device for use with the platform for improving media quality.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of portable cloud services for media and data distribution, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present platform includes a subset of standard REST APIs, significantly reducing software complexity. Reducing the software complexity allows the software to be deployed on hardware other than the high-powered servers of a datacenter. For example, the software can be deployed on significantly smaller and less complex devices, including mobile devices and tablets, taking advantage of advances in computing power and energy efficiency in the mobile device and tablet computing space. Being able to provide cloud software using mobile hardware enables applications to operate even when not connected to the internet as long as a local network connection to the mobile device is available.

Embodiments of the present disclosure may comprise methods, systems, and a computer readable medium comprising, but not limited to, an operating-system-independent computer, such as a virtual machine, a rack server, a mobile device, or a single-board computer that includes at least one of the following:
A. A Messaging Module;
B. A Storage Module;
C. A Packaging Module;
D. An Encoding Module;
E. A Converting Module; and
F. A Networking Module.

Details with regards to each module is provided below. Although modules are disclosed with specific functionality, it should be understood that functionality may be shared between devices, with some functions split between devices, while other functions may be duplicated by the various devices. Furthermore, the name of each device should not be construed as limiting upon the functionality of the device. Moreover, each component disclosed within each device can be considered independently without the context of the other components within the same device or different devices. Each component may contain language defined in other portions of this specifications. Each component disclosed for one device may be mixed with the functionality of another device. In the present disclosure, each component can be claimed on its own and/or interchangeably with other components of other modules.

Consistent with embodiments of the present disclosure, a method may be performed by at least one of the devices disclosed herein. The method may be embodied as, for example, but not limited to, computer instructions, which when executed, perform the method.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

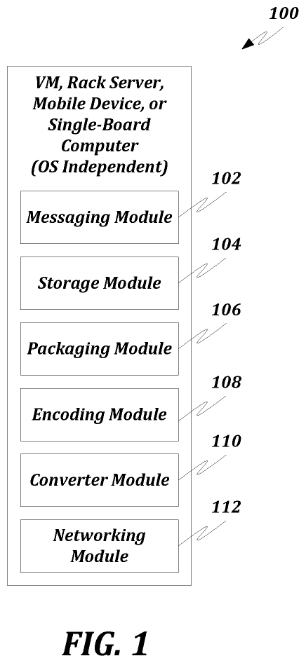

FIG. 1 illustrates one possible operating environment through which a platform consistent with embodiments of the present disclosure may be provided. By way of non-limiting example, at least a portion of a platform 100 may be hosted on, for example, a computing device which is relatively low powered (e.g., when compared to a datacenter server computer), such as a mobile device (e.g., a smartphone or tablet computer), a single-board computer, or a rack server. In some embodiments, the platform 100 may be hosted on a virtual machine or other logical division of a computing device. A user may access platform 100 through a software application and/or hardware device. The software application may be embodied as, for example, but not be limited to, a website, a web application, a desktop application, and a mobile application compatible with the computing device.

In embodiments, the platform 100 may be configured to receive and respond to requests. In embodiments, the requests received by the platform are formatted as though they are being transmitted to a cloud server. However, the platform 100 may not be a cloud server. For example, platform 100 may be embodied as a personal computer, tablet computer, smartphone, or the like. This enables a device, (e.g., a computer, a mobile device, etc.) to consume localized cloud services without the network delay required for transmission of data to and from data centers. For example a mobile device or other computing device may be configured as the platform 100. That same device may access a cloud service running on the platform. Additionally or alternatively, computers and other mobile devices connected to the same local or remote network may consume cloud service provided via the platform 100 embodied on a computer or mobile device via one or more RESTful API requests transmitted to the platform directly. As a particular example, a computer or other mobile device may access Cloud Storage Services hosted on a second mobile device on the same network, where the second mobile device is operating as the platform 100, whether or not a data center server is accessible from the network.

In some embodiments, the requests received at the platform 100 may be REST requests made via a REST API. In particular, the REST API may be abstracted from the actual internal implementation within the platform 100. Using a layered approach, the top layer may implement the API calling sequence. The next layer may adjust incoming parameters for the underlying platform 100, and the final layer may implement the actual API operations. In this way the same API can be implemented on many different hardware/software platforms depending on the platforms' capabilities.

As shown in FIG. 1, the platform 100 may comprise a messaging module 102, a storage module 104, a packaging module 106, an encoding module 108, a converter module 110, and a networking module 112.

Accordingly, embodiments of the present disclosure provide a software and hardware platform comprised of a distributed set of computing elements, including, but not limited to:
A. Messaging Module

The messaging module 102 may comprise hardware and/or software used to send and/or receive messages to and/or from one or more other devices. In some embodiments, the messaging module may operate according to one or more messaging protocols or standards. In embodiments, the messages may comprise data, such as text data, video data, and/or audio data.

In some embodiments, the messaging module 102 may be configured to receive one or more REST requests made via the reduced subset REST API. In particular, the message module 102 may receive a request to retrieve or modify data. The request may include an HTTP verb defining an operation to be performed, a header comprising information related to the request, and an identifier of the resource (e.g., a path to the resource). In some embodiments, the request may further include a message body containing data for use in the request.

There are four HTTP verbs commonly used in requests to interact with resources in a REST system: GET may be used to retrieve a specific resource (e.g., based on a resource ID) or a collection of resources, POST may be used to create a new resource, PUT may be used to update a specific resource (e.g., based on the resource ID), and DELETE may be used to remove a specific resource (e.g., based on the resource ID). In some embodiments, more, fewer, or different HTTP verbs may be accepted by the messaging module 102 without departing from the scope of the invention. For example, the messaging module 102 may not allow for deletion of a resource using a REST request, and/or may not allow for modification of an existing resource user a REST request.

The header of the request may include an indication of a type of content that a client is able to receive from the server. The options for types of content may correspond to Multipurpose Internet Mail Extension (MIME) types, and may include type and a subtype.

The request may include an identifier or path to a resource on which the operation should be performed. The identifier or path may contain information necessary to locate a particular resource or a particular group of resources.

In some embodiments, the messaging module 102 may be configured to respond to a received REST request. The response may include one or more of a header, a status code and/or a data payload.

The header may include information about the response itself. For example, in cases where the response includes a data payload to be sent to the requesting device, the header may include a content-type specifying the format of the data payload. The content-type header field alerts a receiving device to the type of data contained in the data payload. In embodiments, the content types are MIME Types. In some embodiments, the content-type of the data payload in the response corresponds to a content type specified by the requesting device in the request.

The status code may be an HTTP status code that may be used to indicate success or failure of a request. For example, a successful GET request or a successful PUT request may be responded to using HTTP status code 200 (OK), a successful POST request may be responded to using HTTP status code 201 (CREATED), a successful DELETE request may be responded to using HTTP status code 204 (NO CONTENT). Status codes indicating failure may include (but need not be limited to), for example, 400 (BAD REQUEST), 403 (FORBIDDEN), 404 (NOT FOUND), or 500 (INTERNAL SERVER ERROR). There are many HTTP status request codes which may be included in a response.
B. Storage Module

The storage module 104 may comprise hardware and/or software used to store data to and/or retrieve data from one or more hardware storage devices. In some embodiments, the storage module 104 may include long term and or short term hardware storage devices, including, as examples and not by way of limitation, a data cache, a Random Access Memory (RAM), a Flash Memory, a Hard Disk Drive, and/or the like. There are many types of hardware storage devices. The storage module may further include an Input/Output (I/O) system configured to transmit data to and/or from the one or more hardware storage devices. For example, the I/O system may include one or more buses, one or more hardware interface elements (e.g., a network interface), and/or any other hardware and/or software element for communicating data to the one or more storage devices.

In some embodiments, the storage module 104 may be configured to store data to and/or retrieve data from one or more hardware storage devices that are local to the platform 100. Additionally or alternatively, the storage module 104 may be configured to store data to and/or retrieve data from one or more hardware storage devices accessible via a network connection.
C. Packaging Module

The packaging module 106 may comprise hardware and/or software used to package encoded content (e.g., video and/or audio content) for distribution. The packaging module 106 may further comprise hardware and/or software for dividing the content into a plurality of fragments. In some embodiments, the packaging module 106 may comprise hardware and/or software for storing the fragments.

In embodiments, the plurality of fragments into which the content is divided may comprise fragments compatible with a distribution protocol (e.g., using the HTTP Live Streaming [HLS] protocol and/or one or more other streaming content transmission protocols). For example, each fragment may have a length of between about 2 seconds and about 12 seconds. As a particular example, each content fragment may have a length of about 10 seconds. In embodiments, each content fragment may have a name comprising a content identifier (e.g., an alphanumeric string identifying the content) and an index identifier (e.g., an alphanumeric string indicating an index of the particular fragment).
D. Encoding Module

The encoding module 108 may comprise hardware and/or software used to encode content received from a source feed. In some embodiments, the source feed may be video and/or audio data generated by the platform 100 (e.g., via a camera and/or microphone that is part of the platform). In some embodiments, the source feed may be data generated outside of the platform 100 and received at the platform (e.g., via the networking module and/or the messaging module).

In embodiments, the encoding module 108 may encode the content from the source feed to a streaming file format that can be distributed to and consumed by end users at one or more downstream devices. The encoding module 108 may use a video compression algorithm, known as a codec, to compress the content based on one or more quality parameters. As examples, the one or more quality parameters may include a bit rate, a resolution and/or a frequency. There are many quality parameters that may be used by the compression algorithm.

The encoding module 108 may apply the video compression algorithm to the received content from the source feed 202 a plurality of times, using different settings each time. In this way, the encoding module 108 may encode the received content at a plurality of quality levels. This plurality of content quality levels may be useful for adaptive bit rate streaming to the one or more downstream devices. As a particular example, the same content may be encoded into 10 distinct files, with each file having one or more differing quality parameters, such that 10 versions of the content having graduated qualities are available viewing by a viewing device. In this way the content is encoded directly from the source feed to multiple content files, without need for transcoding.
E. Converter Module

The converter module 110 may comprise hardware and/or software used to convert files from one file type to another. For example, the converter module may be configured to convert received video and/or audio data to a streaming file format.
F. Networking Module

The networking module 112 may comprise hardware and/or software used for network communications between the platform 100 and one or more other devices. In embodiments, the networking module may comprise one or more transceivers configured to transmit data to and/or receive data from one or more other devices. In embodiments, the networking module may be configured to connect to the Internet. In some embodiments, the networking module may be configured to form a local area network (e.g., a hub and spoke network, a mesh network, a linear network, etc.). In some embodiments, the networking module may be configured to form a personal area network (e.g., a Bluetooth network, a ZigBee network, etc.).

In embodiments, the networking module 112 may be configured to facilitate receipt of REST API requests for processing by the platform, and to facilitate transmission of responses to the received requests (e.g., via the messaging module 102). In some embodiments, the networking module 112 may be configured to transmit encoded content fragments to one or more downstream devices.
Downstream Devices

One or more downstream devices 114 may comprise hardware and/or software used to process the packaged encoded content. For example, the one or more downstream devices 114 may include one or more playback devices for facilitating playback of the content, one or more devices for cognitive processing of the packaged encoded content, and/or other devices for processing the content. In embodiments, the one or more downstream devices 114 may comprise one or more of a desktop computing device, a laptop computing device, a tablet, a smartphone, a smart tv, a tv set-top box, and/or any other computing device configured to permit processing of a content file (e.g., playback of audio and/or video content).

The downstream device 114 may connect to the platform 100 via the networking module 112. In embodiments, the downstream device may transmit a request for the content to the platform 100. For example, the request may be formatted as a REST-compliant request.

Each downstream device 114 may receive the packaged encoded content from the platform 100. For example, the platform 100 may transmit the packaged encoded content to the downstream device 114 as a response to a request from the downstream device. In particular, the response may be formed as a REST compliant response. As another example, the downstream device may retrieve the packaged encoded content from a data repository or content storage module. As yet another example, the content may be pushed to the downstream device. The downstream device may process the packaged encoded content. Processing the packaged encoded content may comprise decoding the content. In some embodiments, processing the content may include causing playback of the decoded content. In other embodiments, processing the content may comprise performing data analysis on the decoded content. For example, the data analysis may include performing object classification and/or cognitive processing based on the data represented in the content.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### Method of Distributing Streaming Content

Consistent with embodiments of the present disclosure, a method may be performed by at least one of the aforementioned modules. The method may be embodied as, for example, but not limited to, computer instructions, which, when executed, perform the method.

A method for distributing streaming content begins by receiving data, including video and/or audio data. The received data may be processed for distribution. The processing may include (but is not limited to), for example, encoding the data into a streaming video format and/or converting the video data from a first format to a second format, and packaging the encoded data into one or more streaming fragments. The processed data may be stored to a storage device. Thereafter, the system may receive a request for the stored content from a downstream device. The system may respond to the request by transmitting the requested content to the downstream device.

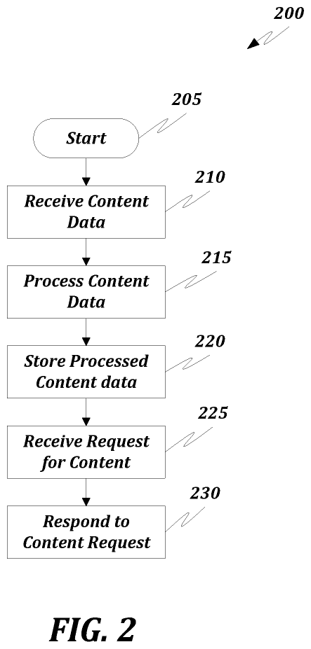

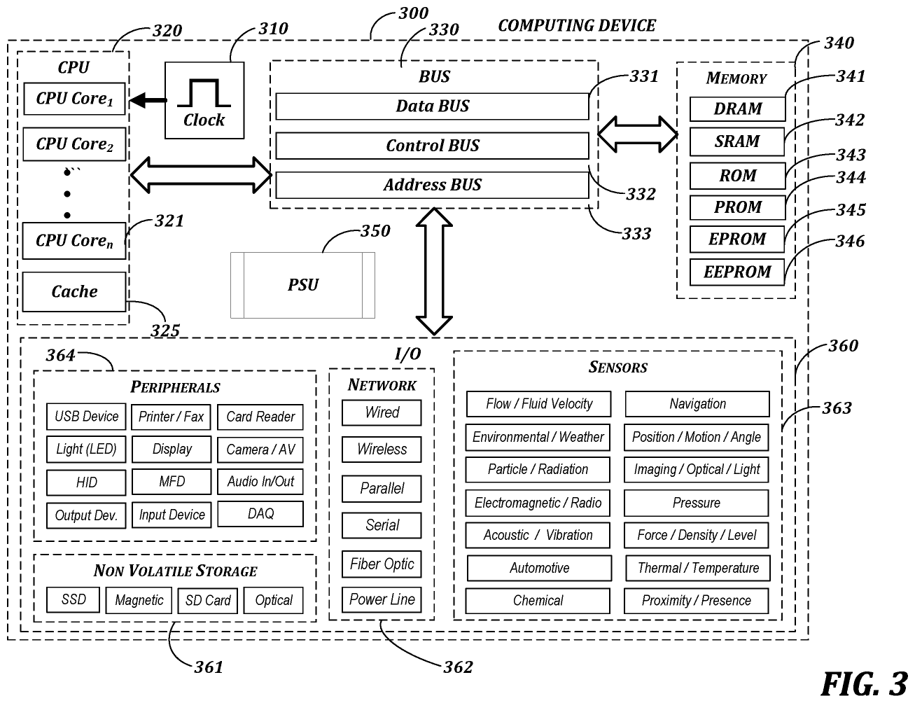

FIG. 2 is a flow chart setting forth the general stages involved in a method 200 consistent with an embodiment of the disclosure for using the platform 100 for distributing streaming content. Method 200 may be implemented using a computing device 300 or any other component associated with platform 100 as described in more detail below with respect to FIG. 3. For illustrative purposes alone, computing device 300 is described as one potential actor in the following stages.

Method 200 may begin at starting block 205 and proceed to stage 210 where computing device 300 may receive data. In embodiments, the data may comprise content, including video and/or audio content data. In some embodiments the data may be received from a content source (e.g., a camera and/or a microphone) connected directly to the computing device or integrated into the computing device. For example, a smartphone may serve as both the computing device 300 and the content source. In other embodiments. The computing device may receive content via a data connection, such as a network connection.

Following receipt of the content data in stage 210, the computing device 300 may process the content data in stage 215. In embodiments, processing the data may include, for example, converting the content data from a first format to a second format, encoding the content data into a format suitable for streaming, and/or packaging the content data for delivery to a downstream device.

Converting the content data may comprise converting the content data from a first file format to a second file format. For example, the content data may arrive as data having a format suitable for transport. As an example, the data may arrive in a data format suited for file transfer (e.g., MPEG transport stream format), and may be converted to a format suitable for file playback (e.g., H.264 format).

Encoding the content data may comprise encoding the content data at a plurality of different quality settings (e.g., suing a plurality of different resolutions and/or bit rates) suitable for differing devices, connection types, and/or data throughput measurements. The different quality settings may allow for a better and/or more stable viewing experience across a plurality of device types and/or connection types and qualities.

Packaging the content data for delivery to a downstream device may comprise dividing the encode data into one or more fragments for distribution to one or more downstream devices. In embodiments, the content fragments may represent relatively short segments of the content data. For example, each content fragment may have a length that does not exceed 10 seconds.

After processing the content data in stage 215, the computing device 300 may store the processed content data in stage 220. Storing the processed content data may include storing the data at a hardware storage device local to the computing device 300 and/or storing the processed content data to a networked storage device (e.g., a network-attached storage device, a storage area network, and/or other networked storage devices).

After storing the processed data in stage 220, the computing device may receive a request for access to a content file in stage 225. In embodiments, the request may include a REST-compliant request. In embodiments, the request may be received from a downstream device configured for playback, display, and/or further processing of the content. As a particular example, the request may be a request for a particular content fragment. As discussed above, the request may include an HTTP verb, a header comprising information related to the request, and an identifier of the content item.

In some embodiments, the HTTP verb for the request may be, for example, GET or another HTTP verb that requests a file to be transmitted to the requesting device. The identifier may include a path, URL, or other identifier of the content the requestor wishes to access. The header may specify, for example, a format and/or quality level at which the requestor wishes to receive the content.

In some embodiments, the request may be received directly from the requesting device. Alternatively, the request may be received via a local area network, or via the internet.

At stage 230, the computing device 300 may respond to a request (e.g., the request received in stage 225). The response may be transmitted to the requesting device.

In embodiments where the request was a REST-compliant request, the response may also be REST-compliant. For example, the response may include a status code, a header, and a data payload. For example, responsive to a determination that the computing device can provide the requested content to the requesting device, the response may include a status code indicating success (e.g., HTTP 200 (OK)). As another example, responsive to a determination that the computing device cannot provide the requested content to the requesting device, the response may include a status code indicating success (e.g., HTTP 403 (FORBIDDEN), HTTP 404 (FILE NOT FOUND), etc.). The data payload may include the requested content item (e.g., the requested content fragment). The header may specify the format and/or the quality level (e.g., bit rate) of the content item in the data payload.

Following transmitting the response, the computing device may optionally continue transmitting fragments of the content item to the requesting device. Alternatively, the computing device may return to a state whereby the computing device is listening for requests (e.g., from the requesting device and/or from any other device).

In this way, a computer or other mobile device may access Cloud Storage Services hosted on another mobile device on the same network, where the second mobile device is operating as the content providing platform (e.g., the platform 100), whether or not a data center server is accessible from the network. This can allow users to stream videos more quickly (e.g., without the need to wait for data to pass through data servers), and/or without the infrastructure required to connect to data servers.

### Computing Device Overview

Embodiments of the present disclosure provide a hardware and software platform operative as a distributed system of modules and computing elements.

Platform 100 may be embodied as, for example, but not be limited to, a website, a web application, a desktop application, backend application, and a mobile application compatible with a computing device 200. The computing device 200 may comprise, but not be limited to the following:

A mobile computing device, such as, but is not limited to, a laptop, a tablet, a smartphone, a drone, a wearable, an embedded device, a handheld device, an Arduino, an industrial device, or a remotely operable recording device;

A microcomputer, wherein the microcomputer computing device comprises, but is not limited to, a server, wherein a server may be a rack mounted server, a blade server, an appliance-based computing resource an accelerator card (such as those manufactured by Xilinx or Intel), a workstation, an industrial device, a raspberry pi, a desktop, or an embedded device;

A purpose-built computing device, wherein the purpose-built computing device comprises hardware and/or software custom designed for a specific deployment environment and/or usage scenario, such as a computing device for use in a satellite or other communication device.

Embodiments of the present disclosure may comprise a system having a central processing unit (CPU) 320, a bus 330, a memory unit 340, a power supply unit (PSU) 350, and one or more Input/Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, the memory unit 340, consistent with embodiments of the disclosure.

At least one computing device 300 may be embodied as any of the computing elements illustrated in all of the attached figures, including the content packager, the metadata generator, the content storage device, and/or the viewing device. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In a basic configuration, computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

A system consistent with an embodiment of the disclosure the computing device 300 may include the clock module 310 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 320, the central component of modern computers, which relies on a clock. The only exceptions are asynchronous circuits such as asynchronous CPUs. The clock 310 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 300 use a “clock multiplier” which multiplies a lower frequency external clock to the appropriate clock rate of the CPU 320. This allows the CPU 320 to operate at a much higher frequency than the rest of the computer, which affords performance gains in situations where the CPU 320 does not need to wait on an external factor (like memory 340 or input/output 360). Some embodiments of the clock 310 may include dynamic frequency change, where the time between clock edges can vary widely from one edge to the next and back again.

A system consistent with an embodiment of the disclosure the computing device 300 may include the CPU unit 320 comprising at least one CPU Core 321. A plurality of CPU cores 321 may comprise identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU unit 320 reads and executes program instructions which may be used across many application domains, for example, but not limited to, general purpose computing, embedded computing, network computing, digital signal processing (DSP), and graphics processing (GPU). The CPU unit 320 may run multiple instructions on separate CPU cores 321 at the same time. The CPU unit 320 may be integrated into at least one of a single integrated circuit die and multiple dies in a single chip package. The single integrated circuit die and multiple dies in a single chip package may contain a plurality of other aspects of the computing device 300, for example, but not limited to, the clock 310, the CPU 320, the bus 330, the memory 340, and I/O 360.

The CPU unit 320 may contain cache 322 such as, but not limited to, a level 1 cache, level 2 cache, level 3 cache or combination thereof. The aforementioned cache 322 may or may not be shared amongst a plurality of CPU cores 321. The cache 322 sharing comprises at least one of message passing and inter-core communication methods may be used for the at least one CPU Core 321 to communicate with the cache 322. The inter-core communication methods may comprise, but not limited to, bus, ring, two-dimensional mesh, and crossbar. The aforementioned CPU unit 320 may employ symmetric multiprocessing (SMP) design.

The plurality of the aforementioned CPU cores 321 may comprise soft microprocessor cores on a single field programmable gate array (FPGA), such as semiconductor intellectual property cores (IP Core). The plurality of CPU cores 321 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the aforementioned computing device 300, and/or the plurality of computing devices 300. The aforementioned communication system will be known to a person having ordinary skill in the art as a bus 330. The bus 330 may embody internal and/or external plurality of hardware and software components, for example, but not limited to a wire, optical fiber, communication protocols, and any physical arrangement that provides the same logical function as a parallel electrical bus. The bus 330 may comprise at least one of, but not limited to a parallel bus, wherein the parallel bus carry data words in parallel on multiple wires, and a serial bus, wherein the serial bus carry data in bit-serial form. The bus 330 may embody a plurality of topologies, for example, but not limited to, a multidrop/electrical parallel topology, a daisy chain topology, and a connected by switched hubs, such as USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 300 may employ hardware integrated circuits that store information for immediate use in the computing device 300, know to the person having ordinary skill in the art as primary storage or memory 340. The memory 340 operates at high speed, distinguishing it from the non-volatile storage sub-module 361, which may be referred to as secondary or tertiary storage, which provides slow-to-access information but offers higher capacities at lower cost. The contents contained in memory 340, may be transferred to secondary storage via techniques such as, but not limited to, virtual memory and swap. The memory 340 may be associated with addressable semiconductor memory, such as integrated circuits consisting of silicon-based transistors, used for example as primary storage but also other purposes in the computing device 300. The memory 340 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 300 may employ the communication system between an information processing system, such as the computing device 300, and the outside world, for example, but not limited to, human, environment, and another computing device 300. The aforementioned communication system will be known to a person having ordinary skill in the art as I/O 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces a plurality of hardware, such as, but not limited to, non-volatile storage 361, communication devices 362, sensors 363, and peripherals 364. The plurality of hardware is used by the at least one of, but not limited to, human, environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ the non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using intermediate area in the memory 340. The non-volatile storage sub-module 361 does not lose data when power is removed and may be two orders of magnitude less costly than storage used in memory module, at the expense of speed and latency. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 300 may employ the communication sub-module 362 as a subset of the I/O 360, which may be referred to by a person having ordinary skill in the art as at least one of, but not limited to, computer network, data network, and network. The network allows computing devices 300 to exchange data using connections, which may be known to a person having ordinary skill in the art as data links, between network nodes. The nodes comprise network computer devices 300 that originate, route, and terminate data. The nodes are identified by network addresses and can include a plurality of hosts consistent with the embodiments of a computing device 300. The aforementioned embodiments include, but not limited to personal computers, phones, servers, drones, and networking devices such as, but not limited to, hubs, switches, routers, modems, and firewalls.

Two nodes can be said are networked together, when one computing device 300 is able to exchange information with the other computing device 300, whether or not they have a direct connection with each other. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 362 may comprise a plurality of size, topology, traffic control mechanism and organizational intent. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 300 may employ the sensors sub-module 363 as a subset of the I/O 360. The sensors sub-module 363 comprises at least one of the devices, modules, and subsystems whose purpose is to detect events or changes in its environment and send the information to the computing device 300. Sensors are sensitive to the measured property, are not sensitive to any property not measured, but may be encountered in its application, and do not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ the peripherals sub-module 362 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 300 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 362 sub-module), data storage device (non-volatile storage 361), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### III. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system comprising:
a portable computing device comprising at least one hardware processor;
the system being configured to perform operations comprising:
receiving, at the portable computing device, content data;
processing, using the portable computing device, the content data such that the processed data is stored as one or more processed content files in a streaming file format that can be distributed to and consumed by end users at one or more downstream devices;
receiving, at the portable computing device, a request for at least one file, of the processed content files; and
distributing the at least one file, of the processed content files, to one or more downstream devices.

2. The system of claim 1, wherein the portable computing device comprises a smartphone.

3. The system of claim 2, wherein the one or more downstream devices establish a direct data connection with the portable computing device.

4. The system of claim 3, wherein neither the portable computing device nor the one or more downstream devices can access a data server.

5. The system of claim 1, wherein the request comprises a REpresentational State Transfer (REST) compliant request.

6. The system of claim 5, wherein distributing the at least one file comprises distributing the at least one file as part of a response to the REST compliant request.

7. The system of claim 1, wherein processing the content data comprises one or more of:
converting the content data from a first file format to a second file format,
encoding the content data at one or more defined bit rates, or
packaging the content data into one or more content fragments for streaming delivery.

8. A method comprising:
receiving, at a portable computing device, content data;
processing, using the portable computing device, the content data such that the processed data is stored as one or more processed content files in a streaming file format that can be distributed to and consumed by end users at one or more downstream devices;
receiving, at the portable computing device, a request for at least one file, of the processed content files; and
distributing the at least one file, of the processed content files, to one or more downstream devices.

9. The method of claim 8, wherein the portable computing device comprises a smartphone.

10. The method of claim 9, further comprising establishing a direct data connection between the one or more downstream devices and the portable computing device.

11. The method of claim 10, wherein neither the portable computing device nor the one or more downstream devices can access a data server.

12. The method of claim 8, wherein the request comprises a REpresentational State Transfer (REST) compliant request.

13. The method of claim 12, wherein distributing the at least one file comprises distributing the at least one file as part of a response to the REST compliant request.

14. The method of claim 8, wherein processing the content data comprises one or more of:
converting the content data from a first file format to a second file format,
encoding the content data at one or more defined bit rates, or
packaging the content data into one or more content fragments for streaming delivery.

15. One or more non-transitory computer readable media comprising instructions which, when executed by one or more hardware processors, causes performance of operations comprising:
receiving, at a portable computing device, content data;
processing, using the portable computing device, the content data such that the processed data is stored as one or more processed content files in a streaming file format that can be distributed to and consumed by end users at one or more downstream devices;
receiving, at the portable computing device, a request for at least one file, of the processed content files; and
distributing the at least one file, of the processed content files, to one or more downstream devices.

16. The non-transitory computer readable media of claim 15, wherein the portable computing device comprises a smartphone.

17. The non-transitory computer readable media of claim 15, wherein execution of the instructions further causes performance of operations comprising establishing a direct data connection between the one or more downstream devices and the portable computing device.

18. The non-transitory computer readable media of claim 17, wherein neither the portable computing device nor the one or more downstream devices can access a data server.

19. The non-transitory computer readable media of claim 15, wherein the request comprises a REpresentational State Transfer (REST) compliant request.

20. The non-transitory computer readable media of claim 15, wherein processing the content data comprises one or more of:
converting the content data from a first file format to a second file format,
encoding the content data at one or more defined bit rates, or
packaging the content data into one or more content fragments for streaming delivery.
